(19) United States
(12) Patent Application Publication
(10) Pub. No.: US 2024/0117789 A1
(43) Pub. Date: Apr. 11, 2024

(54) APPARATUS FOR CONVERTING FLUID KINETIC ENERGY INTO RECIPROCATING MOTION

(71) Applicant: Robert Moss, Dearborn Heights, MI (US)

(72) Inventor: Robert Moss, Dearborn Heights, MI (US)

(21) Appl. No.: 17/961,758

(22) Filed: Oct. 7, 2022

(51) Int. Cl. F03D 15/10; F03D 3/00; F03D 3/06

(52) U.S. Cl. CPC F03D 15/10; F03D 3/005; F03D 3/062; F05B 2240/3052; F05B 2240/31; F05B 2260/50; F05B 2280/4007; F05B 2280/6001

(57) ABSTRACT

An apparatus for converting kinetic energy of a fluid into reciprocating motion includes a rod mounted for reciprocating motion along a substantially vertical direction, an airfoil mounted on the rod, and control surfaces for selectively moving the airfoil upwardly and downwardly in a fluid stream.

### FIELD OF THE DISCLOSURE

The disclosed apparatus relates to energy production from renewable sources, and in particular to converting the kinetic energy of wind or fluid flow into a reciprocating motion capable of being transferred into rotational motion.

### BACKGROUND OF THE DISCLOSURE

Convention wind turbines rely on large blades (often 70 ft or more in length) generally made of solid fiber-reinforced composites that are very difficult to recycle. It was originally estimated that these blades would have a service life of at least twenty years. In practice, the service life has often been considerably shorter (e.g., less than 15 years, and even less than 10 years in some cases). Due to the shorter than expected service life and the extreme difficulty in recycling these blades, they are accumulating in landfills in huge numbers. Another well known issue with conventional wind turbines is that the tips of the blades often travel at supersonic speeds creating a high risk of bird strikes. Advocates of conventional wind turbines often attempt to minimalize this problem by arguing that the number of wind turbine bird kills is a fraction of those killed by domestic cats. This is a mischaracterization of the problem, since cats never kill majestic birds of prey such as the American eagle, whereas wind turbines do on a regular basis.

While most, essentially all practical, attempts to obtain energy from wind and water currently have involved directly converting fluid kinetic energy into rotary motion, there have been essentially no successful examples of apparatuses for converting fluid kinetic energy into reciprocating motion.

### SUMMARY OF THE DISCLOSURE

Described is an apparatus for converting kinetic energy of a fluid into reciprocating motion. The apparatus includes a rod that is supported for reciprocating motion along a substantially vertical direction, and an airfoil mounted to the rod. Coupled to the airfoil is a control surface that can be moved relative to the airfoil to selectively move up and down from wind or other fluid flow over a surface of the airfoil. The control surface can be an elevator and/or an aileron. The elevator(s) and/or aileron(s) can be controlled by actuators that are operated by an electronic controller to cause the airfoil to move in a periodic reciprocating manner.

The reciprocating motion of the rod attached to the airfoil can be converted into rotary motion to, for example, drive an impeller of a pump or a rotor of an electrical generator.

### BRIEF DESCRIPTION OF THE DRAWINGS

FIG. 1 is a schematic illustration of an apparatus for converting kinetic energy of a fluid into reciprocating motion, and for converting the reciprocating motion into rotary motion.

FIG. 2 shows a plurality of apparatuses of FIG. 1 used to drive a crank shaft.

FIG. 3 is a schematic illustration of the apparatus of FIG. 1, with a modification of the mechanism for converting reciprocating motion into rotary motion.

FIG. 4 is a schematic illustration of the apparatus of FIG. 1 being used to drive a rotor of an electric generator.

FIG. 5 is a schematic illustration of the apparatus of FIG. 1 being used to drive an impeller of a pump.

FIG. 6 is a drawing of the construction of an airfoil used in the apparatus of FIG. 1.

FIG. 7 is a schematic illustration of another embodiment of an apparatus for converting kinetic energy of a fluid into reciprocating motion of two rods and rotational movement of two corresponding shafts.

### DETAILED DESCRIPTION OF THE ILLUSTRATED EMBODIMENT(S)

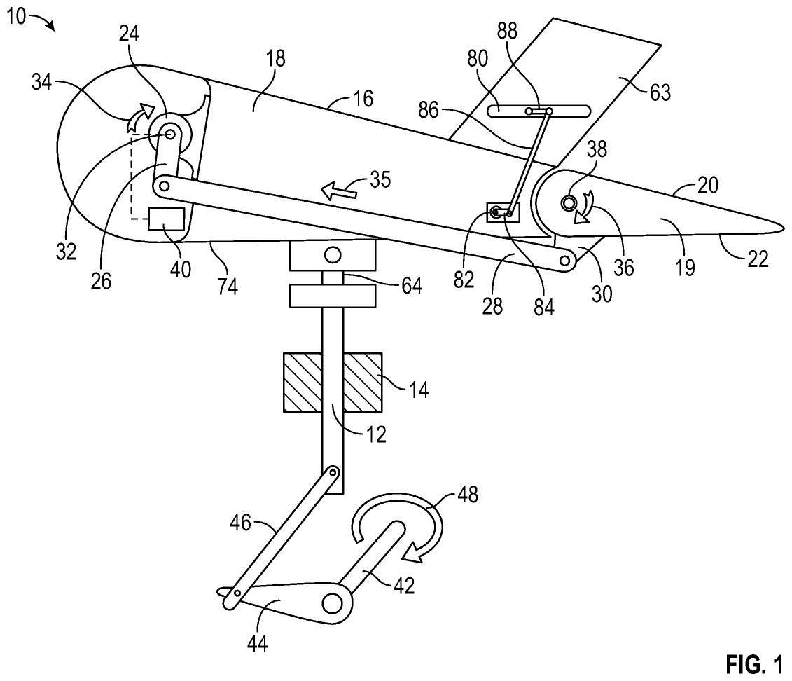

Shown in FIG. 1 is an apparatus 10 for converting kinetic energy of a fluid, such as air or water, into reciprocating motion. Apparatus 10 includes a rod 12 supported for reciprocating motion, such as by a slider 14 which is supported by a tower or other structure (which is not shown), along a substantially vertical direction approximately normal to the ground such that wind or water currents moving over a lift surface 16 on an upper side of an airfoil 18 can create lift to move airfoil 18 and attached rod 12 upwardly. An aileron structure 19 having control surfaces 20, 22 is hingedly connected to a trailing edge of the wing-like airfoil 18. An actuator 24, such as an electric motor, is mechanically coupled to the aileron structure 19 to pivot the aileron structure relative to the airfoil to selectively increase and decrease lift from fluid moving over surfaces of the airfoil. Actuator 24 can be located within a leading section of the airfoil as shown in FIG. 1, and mechanically coupled to the aileron structure by a crank 26 and linkage rod 28 pivotably connected at one end to crank 26 and pivotably connected at an opposite end to an aileron crank 30 When the shaft 32 of motor 24 and crank 26 are rotated clockwise (as indicated by the direction of arrow 34), linkage rod 28 moves left (as indicated by the direction of arrow 35) causing aileron structure 19 to rotate clockwise (as indicated by the direction of arrow 26) around a pivot 38 increasing lift and causing airfoil 18 and attached rod 12 to move vertically upward. When shaft 32 of motor 24 is rotated counter-clockwise (opposite of the direction indicated by arrow 34) aileron structure 19 is rotated counter-clockwise (opposite of the direction indicated by arrow 36), which decreases lift on airfoil 18 causing airfoil 18 and rod 12 to move vertically downward.

A controller 40 can be used to control actuator 24 to periodically adjust aileron structure 19 to cause a reciprocating motion of rod 12.

The reciprocating motion of rod 12 can be converted into rotational motion of a shaft which can be used to do work or generate electricity.

An example of a mechanism for converting reciprocating motion of rod 12 into rotational motion of a shaft is shown in FIG. 1. A rotational shaft 42 is provided with a shaft crank 44 rotationally fixed to shaft 42. A distal end of shaft crank 44 is pivotably connected with a first end of a rotary linkage 46, and an opposite second end of rotary linkage 46 is pivotably connected to a lower end of rod 12, such that reciprocating movement of rod 12 causes shaft 42 to rotate as indicated by arrow 48.

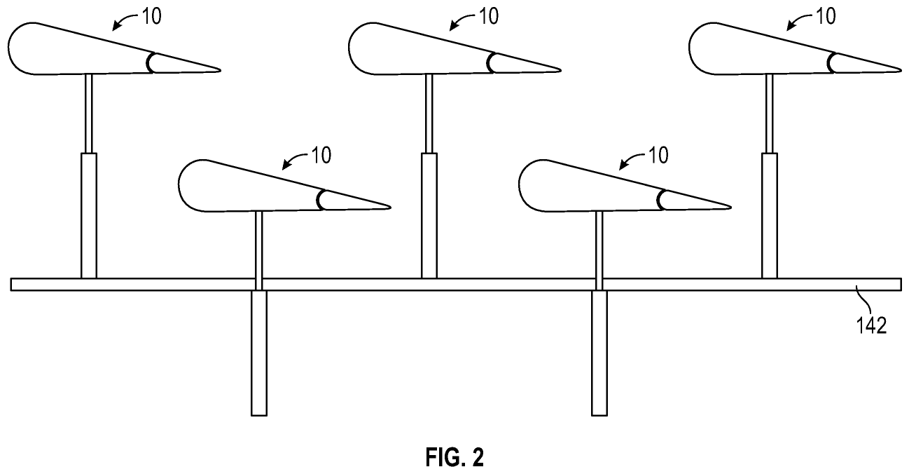

As indicated in FIG. 2, a plurality of apparatuses can be linked to a single crank shaft 142 (schematically represented) to increase the torque to the shaft.

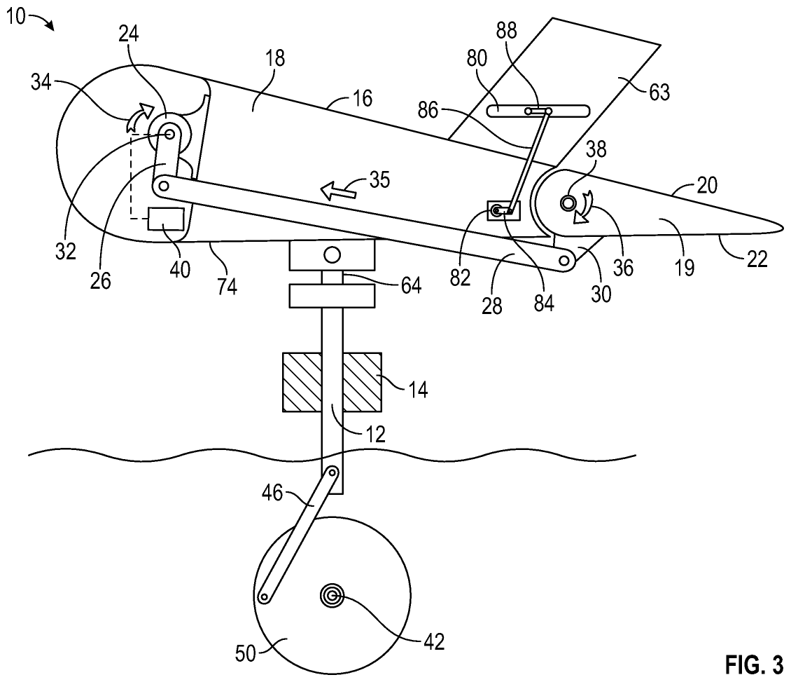

FIG. 3 shows a slightly modified mechanism for converting the reciprocating motion of rod 12 into rotational motion of shaft 42. Rather than employing an arm-like crank 44, the apparatus of FIG. 3 is coupled to shaft 42 via a crank disk 50.

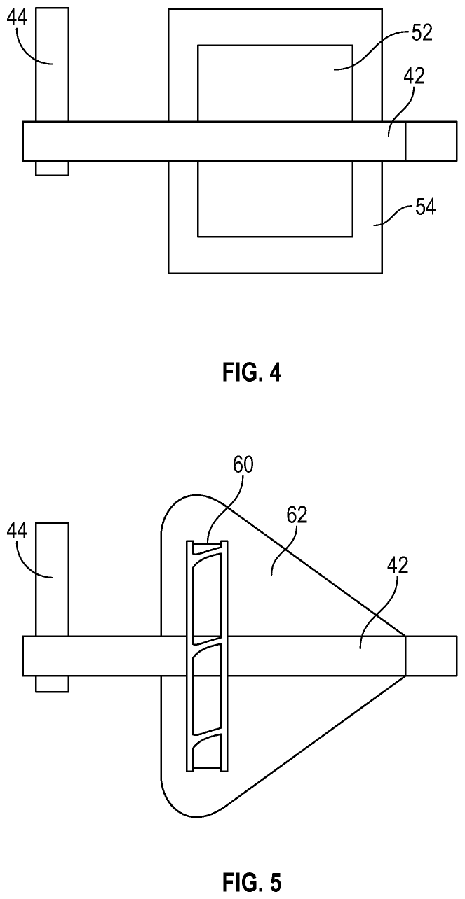

FIG. 4 shows shaft 42 driving a rotor 52 of an electric generator 54.

FIG. 5 shows shaft 42 used to rotate an impeller 60 of a pump 62.

Apparatus 10 can include an airfoil 18 that is mounted at an upper end of a rod 12 for rotational movement around a substantially vertical axis via a swivel joint 64. This allows airfoil 18 to rotate so that a leading edge of the lift surface faces into the wind or direction from which air, water or other fluid is moving. Such rotation could be achieved using an electric motor operated by a controller receiving fluid flow direction data from one or more sensors. However, a simpler approach is to provide airfoil 18 with a rudder blade 63 that automatically turns the airfoil into the direction from which fluid is moving.

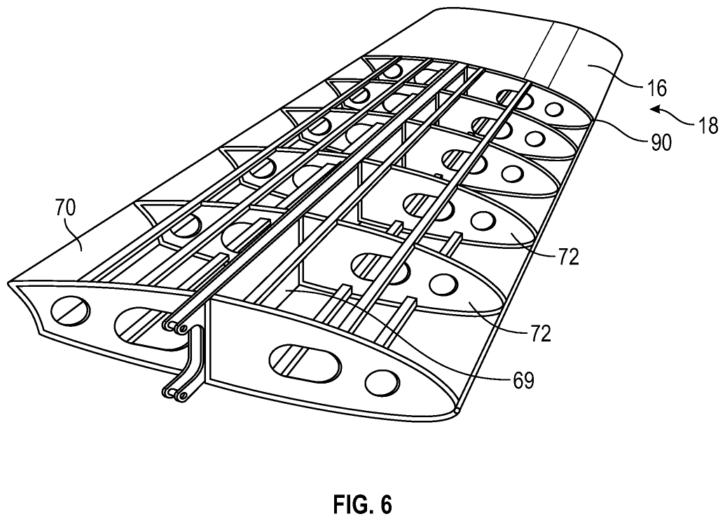

As illustrated in FIG. 6, airfoil 18 is structurally similar to a conventional wing of an aircraft. Airfoil 18 is comprised of front and rear spars 69, 70 extending along the length of the airfoil and ribs 72 that are transverse to the spars and extend from the leading edge of the airfoil to the trailing edge 90 to define the shape of the airfoil. The spars and ribs can be comprised of lightweight materials, such as aluminum, wood, or carbon fiber reinforced composites. The upper lift surface 16 and lower surface 74 or skins are preferably comprised of durable lightweight materials such as doped fabrics or thermoplastic films. A suitable fabric covering for the upper and lower surfaces of airfoil 18 is a polyester fabric. A suitable thermoplastic film for the upper and lower airfoil surfaces is biaxially-oriented polyethylene terephthalate film. Aileron structure 19 can have a construction similar to that of airfoil 18.

As an alternative to, or in addition to aileron structure 19, apparatus 10 can be provided with an elevator 80 for changing the angle of attack of airfoil 19. Elevator 80 is analogous and similar to the elevators that are employed on conventional aircraft. In the illustrated embodiment of FIG. 1, elevator(s) 80 (only one is illustrated, but two can be employed, with one on each of the opposite sides of rudder blade 63) extends generally perpendicularly from rudder 63. However, other structures can be provided for structurally coupling elevator(s) 80 to airfoil 18 without employing rudder 63. An elevator actuator 82 (e.g., an electric motor) can be provided to adjust the pitch of elevator 80 and the angle of attack of airfoil 18. Actuator 82 can be mechanically coupled to elevator(s) 80 via cranks 84, 88 and elevator linkage 86 (e.g., similar to the mechanical coupling used to link actuator 24 with aileron structure 19). Actuator 82 can be operated using a processor, such as controller 40.

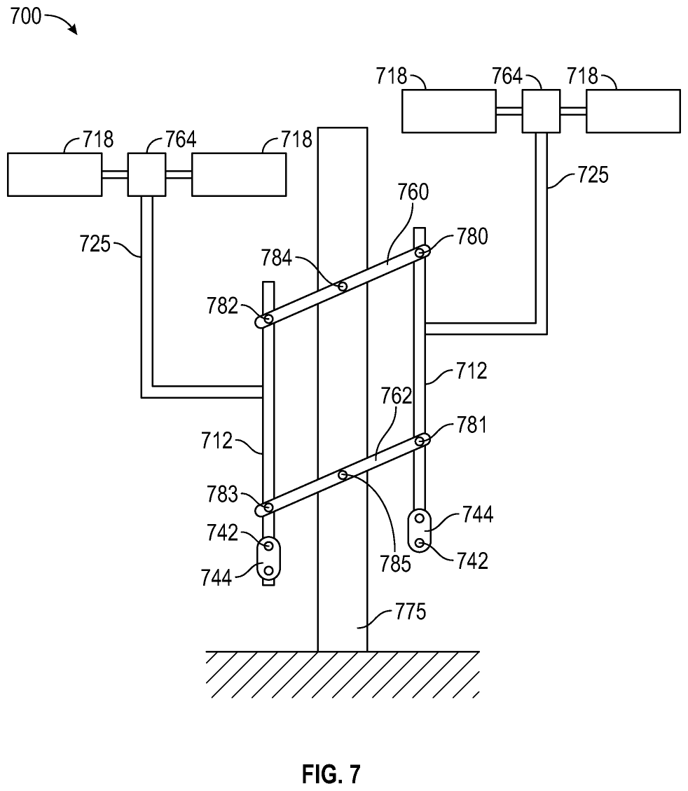

The described apparatuses have certain advantages over conventional wind turbines, including reduced risk of bird strikes and the use of lightweight, easily recyclable materials. FIG. 7 shows another embodiment 700 having a plurality of airfoils 718 (which can be generally similar to airfoil 18 including various control surfaces such as elevators and ailerons), two of which are mounted to each of two swivels 764 that allow airfoils 718 to rotate into the wind (or fluid current). A cantilever support member 725 supports each swivel 764 and airfoils 718 off of reciprocating rods 712, which are pivotably connected to cranks 744 that are fixed to rotatable shafts 742. Rods 712 are linked together and supported by linkage members 760, 762, which are in turn pivotably supported on a tower 775. Linkages 760, 762 include pivots 780, 781, 782, 783, 784 and 785 that allow rods 712 to reciprocate together in opposite directions (one moves upwardly while the other moves downwardly). Control surfaces (e.g., ailerons and/or elevators) can be operated (such as by an electronic controller or microcomputer) to cause airfoils on one of the swivels 764 to move upwardly while the airfoils on the other swivel move downwardly to cause rods 712 to reciprocate in opposite directions to drive shafts 742, which can for example be used to drive a turbine of an electric generator or an impeller on a pump.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the claims attached herein.

1. An apparatus for converting kinetic energy of a fluid into reciprocating motion, comprising:
a rod supported for reciprocating motion along a vertical direction;
an airfoil connected to the rod, the airfoil having an upper lift surface;
an aileron hingedly connected at a trailing edge of the airfoil; and
an electric motor positioned within or on the airfoil, and mechanically coupled to the aileron to pivot the aileron relative to the airfoil to selectively increase and decrease lift from the fluid moving over surfaces of the airfoil.

2. The apparatus of claim 1, further comprising a mechanism for converting reciprocating motion of the rod into rotational motion of a shaft.

3. The apparatus of claim 2, wherein the mechanism for converting reciprocating motion of the rod into rotational motion is a crank.

4. The apparatus of claim 3, wherein the crank is pivotably connected with a lower end of the rod by a connecting rod.

5. The apparatus of claim 3, wherein the crank is an arm extending away from the shaft.

6. The apparatus of claim 3, wherein the crank is a disk attached to the shaft.

7. The apparatus of claim 2, further comprising an electric generator having a rotor coupled to the shaft.

8. The apparatus of claim 2, further comprising a pump having an impeller coupled to the shaft.

9. The apparatus of claim 1, wherein the airfoil is mounted for rotational movement around a vertical axis, and further comprising a rudder blade coupled to the airfoil to rotate a leading edge of the airfoil into a direction of fluid flow over the airfoil.

10. The apparatus of claim 1, wherein the airfoil is comprised of a framework having ribs and spars comprised of aluminum, wood or a carbon fiber reinforced composite.

11. The apparatus of claim 10, wherein the airfoil is further comprised of a fabric covering that forms the upper lift surface and a lower covering opposite the lift surface.

12. The apparatus of claim 11, wherein the fabric is a polyester fabric.

13. The apparatus of claim 10, wherein the airfoil is further comprised of a thermoplastic film covering that forms the upper lift surface and a lower covering opposite the lift surface.

14. The apparatus of claim 13, wherein the film is a biaxially-oriented polyethylene terephthalate film.

15. An apparatus for converting kinetic energy of a fluid into reciprocating motion, comprising:
a rod supported for reciprocating motion along a vertical direction;
an airfoil having a leading edge and a trailing edge, the airfoil mounted to the rod;
an elevator structurally coupled to the airfoil, the elevator hingedly connected to the structural coupling; and
an electric motor positioned within or on the airfoil for adjusting a pitch of the elevator and an angle of attack of the airfoil.

16. The apparatus of claim 15, further comprising a mechanism for converting reciprocating motion of the rod into rotational motion of a shaft.

17. The apparatus of claim 16, further comprising an electric generator having a rotor coupled to the shaft.

18. The apparatus of claim 16, further comprising a pump having an impeller coupled to the shaft.

19. The apparatus of claim 15, wherein the airfoil is comprised of a framework having ribs and spars comprised of aluminum, wood or a carbon fiber reinforced composite.

20. The apparatus of claim 15, wherein the airfoil is comprised of a framework having ribs and spars comprised of aluminum, wood or a carbon fiber reinforced composite; and wherein the airfoil is further comprised of a fabric or thermoplastic film covering that forms the upper lift surface and a lower covering opposite the lift surface.

21. The apparatus of claim 1, further comprising a second rod supported for reciprocating motion along a substantially vertical direction, and at least a second airfoil mounted to the second rod, and linkages connecting the rods for reciprocal motion together in opposite directions.

22. An apparatus for converting kinetic energy of a fluid into reciprocating motion; comprising:
a rod supported for reciprocating motion along a vertical axis;
an airfoil connected to the rod, the airfoil having an upper lift surface;
a control surface connected with the airfoil and movable in relation to the airfoil; and
an electric motor positioned within or on the airfoil for effecting movement of the control surface to cause the airfoil to selectively move upwardly and downwardly.
